(19) United States
(12) Patent Application Publication
(10) Pub. No.: US 2018/0271266 A1
(43) Pub. Date: Sep. 27, 2018

(54) CLEANING BRUSH

(71) Applicant: Yu-Ching LIN, Chia-Yi City (TW)

(72) Inventor: Yu-Ching LIN, Chia-Yi City (TW)

(21) Appl. No.: 15/469,242

(22) Filed: Mar. 24, 2017

(51) Int. Cl. A46B 3/18; A46B 9/02; A46B 9/06; B25G 3/36; A46B 5/00

(52) U.S. Cl. CPC A46B 3/18; A46B 9/026; A46B 2200/3073; B25G 3/36; A46B 5/0095; A46B 9/06

(57) ABSTRACT

A cleaning brush includes a rod body having a first end and a second end. The first end of the rod body includes a first connecting portion. The second end of the rod body includes a first bristle portion and a second bristle portion. A storage portion free of bristles is formed between the first and second bristle portions. An engaging member includes a first end and a second end. The first end of the engaging member includes a second connecting portion engaged with the first connecting portion. The second end of the engaging member includes a first engaging portion.

### BACKGROUND OF THE INVENTION

The present invention relates to a cleaning brush and, more particularly, to a cleaning brush for thoroughly cleaning various dusts in a hole, thereby providing a cleaning effect in the hole.

FIG. 1 shows a conventional hole cleaning brush 9 including a rod body 91 having an end extending helically. Bristles are fixed to the end of the rod body 91 to form a bristle portion 92. An engaging portion 93 is formed on the other end of the rod body 91 and can be used to couple the hole cleaning brush 9 to an electric tool. Examples of such a hole cleaning brush 9 have been disclosed in JP 3188142 U entitled “HOLE CLEANING PEN” and JP 3205767 U entitled “CLEANING BRUSH”.

Since the bristle portion 92 of the conventional hole cleaning brush 9 is continuously arranged in a helical pattern, when the conventional hole cleaning brush 9 is used in cleaning dust, such as cement or wood dust, in a hole, the dust in the hole will accumulate in and covers the whole helically extending bristle portion 92. Thus, the dust adhered to the bristle portion 92 has to be troublesomely removed before reuse of the conventional hole cleaning brush 9. Removal of the dust is difficult, such that the dust in the hole cannot be effectively cleaned during reuse of the conventional hole cleaning brush 9. Furthermore, in a case that an adhesive is subsequently filled into the hole for coupling with a to-be-connected object, the to-be-connected object cannot be securely coupled. Furthermore, a user is less willing to reuse the hole cleaning brush 9 due to the inconvenience and difficulties in cleaning, and the hole conventional brush 9 has a short service life.

### BRIEF SUMMARY OF THE INVENTION

To solve the above disadvantages, the present invention provides a cleaning brush that permits easy and thorough removal of dust adhered thereto while cleaning dust in a hole, such that the cleaning brush can be reused to prolong the service life of the cleaning brush.

Another objective of the present invention is to provide a cleaning brush for effectively cleaning the dust in the hole, and an adhesive is the filled into the hole for securely coupling a to-be-connected object.

A cleaning brush according to the present invention includes a rod body having a first end and a second end. The first end of the rod body includes a first connecting portion. The second end of the rod body includes a first bristle portion and a second bristle portion. A storage portion free of bristles is formed between the first and second bristle portions. An engaging member includes a first end and a second end. The first end of the engaging member includes a second connecting portion engaged with the first connecting portion. The second end of the engaging member includes a first engaging portion.

By such an arrangement of the cleaning brush according to the present invention, since the rod body includes the first and second bristle portions and the storage portion between the first and second bristle portions, when the cleaning brush is used to clean a hole, the first bristle portion firstly stirs up the dust residing in the hole, and the dust can only remain in the storage portion. Then, the second bristle proceeds with deeper cleaning to thoroughly remove the dust in the hole. This permits a secure coupling effect of a to-be-connected object by filling an adhesive into the hole after cleaning. After the cleaning job, the dust remaining in the storage portion can be easily removed. Thus, the cleaning brush according to the present invention can rapidly and easily clean the dust, and the user is willing to reuse the cleaning brush. Thus, the cleaning brush has a longer service life.

In an example, the rod body is formed by twisting two metal wires to provide the first and second bristle portions. Thus, the first and second bristle portions can be securely fixed to the rod body.

In an example, the rod body is formed by twisting four metal wires to provide the first and second bristle portions. Thus, the first and second bristle portions can be securely fixed to the rod body.

In an example, each of the first and second bristle portions has an axial length, and the axial lengths of the first and second bristle portions are identical or different. Thus, the cleaning brush can clean holes of different depths.

In an example, each of the first and second bristle portions has a rotational diameter when rotated, and the rotational diameters of the first and second bristle portions are identical or different. Thus, the cleaning brush can clean holes of different diameters.

In an example, the first and second bristle portions can be made of the same material or different materials. Thus, the cleaning brush can clean dusts in holes of different materials.

In an example, the cleaning brush further includes an extension member having a first end and a second end. A third connecting portion is formed on the second end of the engaging member. The first end of the extension member includes a fourth connecting portion engaged with the third connecting portion. The second end of the extension member has a second engaging portion. Thus, the cleaning brush can provide wider and more versatile effects.

In an example, the third connecting portion is in threading connection with the fourth connecting portion. Thus, the cleaning brush can provide wider and more versatile effects.

The present invention will become clearer in light of the following detailed description of illustrative embodiments of this invention described in connection with the drawings.

### DESCRIPTION OF THE DRAWINGS

FIG. 1 is a perspective view of a conventional hole cleaning brush.

FIG. 2 is an exploded, perspective view of a hole cleaning brush of an embodiment according to the present invention.

FIG. 3 is a partial, perspective view of the hole cleaning brush of FIG. 2, illustrating coupling of a rod body and an engaging member.

FIG. 4 is a cross sectional view of the hole cleaning brush of FIG. 2 after assembly.

FIG. 5 is a cross sectional view of a rod body of an example according to the present invention.

FIG. 6 is a cross sectional view of a rod body of another example according to the present invention.

FIG. 7 is an exploded, perspective view of a hole cleaning brush of a second embodiment according to the present invention.

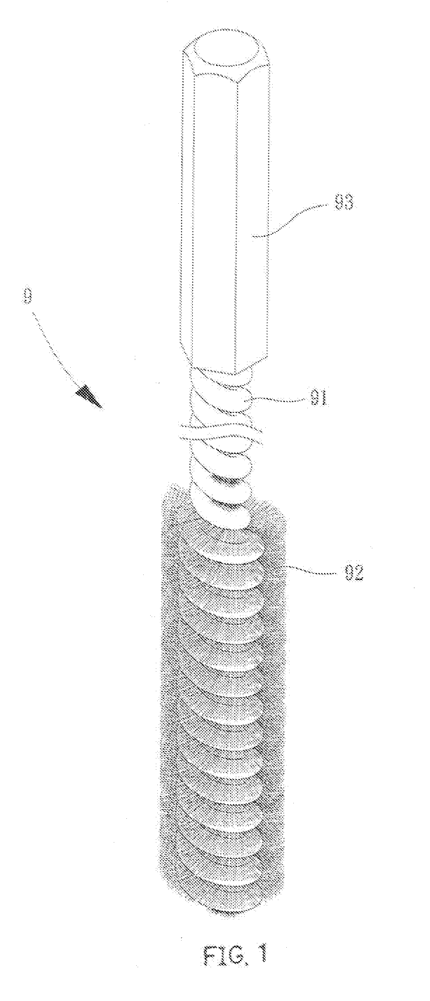

### DETAILED DESCRIPTION OF THE INVENTION

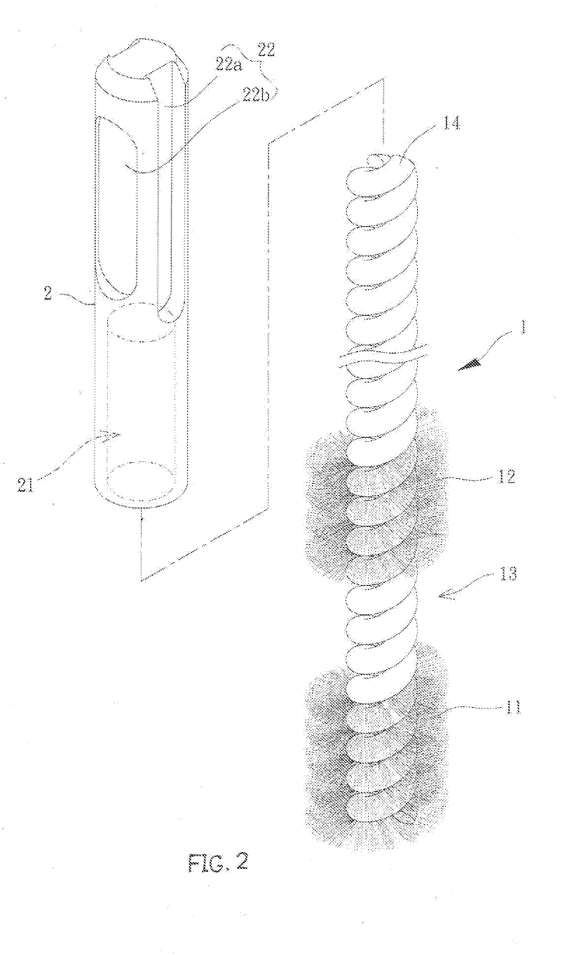

With reference to FIG. 2, a cleaning brush of a first embodiment according to the present invention includes a rod body 1 and an engaging member 2. The engaging member 2 is engaged with a first end of the rod 1 to constitute the cleaning brush according to the present invention.

Still referring to FIG. 2, the rod body 1 is formed by a metal wire having better strength. The metal wire can be a conventional steel cord. Furthermore, the metal wire can be twisted to form the rod body 1. During twisting for forming the rod body 1, bristles can be twisted and fixed by the metal wire. Thus, the bristles are twisted and clamped at a second end of the rod body 1 in a helical pattern. Furthermore, the bristles can have a discontinuous section to form first and second bristle portions 11 and 12 on the second end of the rod body 1. The discontinuous section forms a storage portion 13 free of bristles.

Each of the first and second bristle portions 11 and 12 has an axial length. The axial lengths of the first and second bristle portions 11 and 12 are identical or different. Furthermore, each of the first and second bristle portions 11 and 12 has a rotational diameter when rotated. The rotational diameters of the first and second bristle portions 11 and 12 are identical or different. Furthermore, the first and second bristle portions 11 and 12 can be made of the same material or different materials, such as metal, nylon strings, etc. Thus, the cleaning brush can provide wider and versatile effects. A first connecting portion 14 is formed on the first end of the rod body 1 for coupling with the engaging member 2.

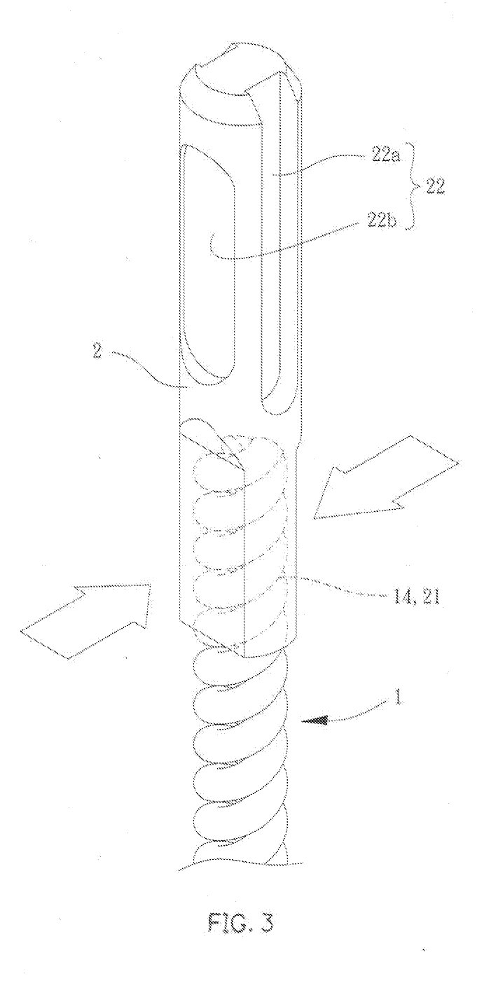

With reference to FIGS. 2 and 3, the engaging member 2 includes a first end and a second end. The first end of the engaging member 2 includes a second connecting portion 21 engaged with the first connecting portion 14. The second engaging portion 21 is preferably a hole. Thus, the rod-like first connecting portion 14 can be directly inserted into and coupled with the second connecting portion 21. The coupling can be conventional welding or punching to form a reduced section. In this embodiment, the first connecting portion 14 is directly inserted into the second connecting portion 21, and punching or other suitable provisions are carried out to form a reduced section in the second connecting portion 21, thereby securely coupling the rod body 1 with the engaging member 2 as an integral member. A first engaging portion 22 is formed on the second end of the engaging member 2 and can be in the form of an elongated groove 22a or a short slot 22b, which is conventional. Thus, the engaging member 2 can be coupled by the engaging portion 22 with a tool, such as an electric tool, a pneumatic tool, or an electric screw driver, and can be driven by the tool to rotate.

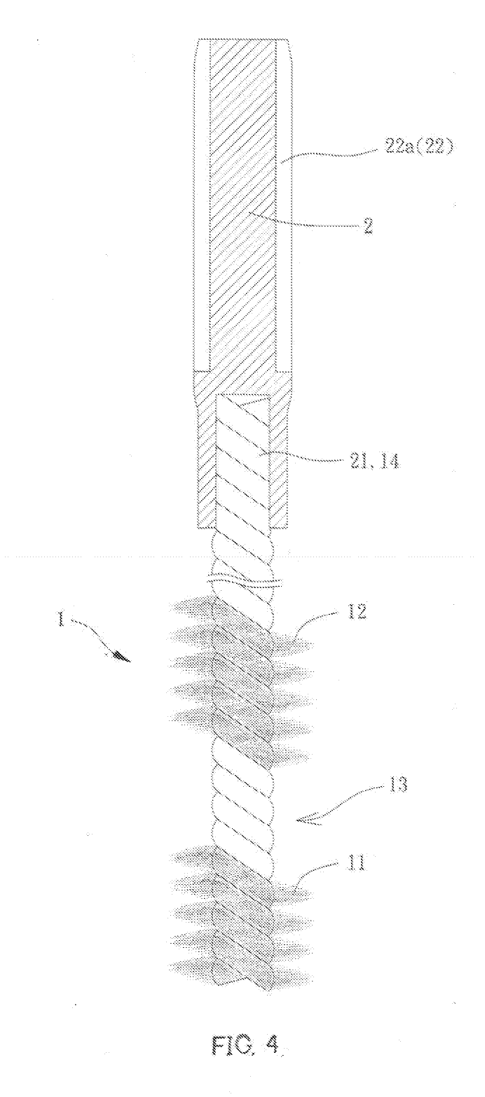

With reference to FIG. 4, after the rod body 1 is engaged with the engaging member 2, the first connecting portion 14 of the rod body 1 is inserted into the second connecting portion 21 in the form of a hole, and the second connecting portion 21 is formed with a reduced section to firmly couple with the first connecting portion 14, thereby coupling the rod body 1 with the engaging member 2 as an integral member. The second end of the rod body 1 includes first and second bristle portions 11 and 12 and a storage portion 13 between the first and second bristle portions 11 and 12.

When the cleaning brush is used to clean a hole, the rod body 1 is driven to rotate. The first bristle portion 11 of the rod body 1 firstly stirs up the dust residing in the hole. Since the first bristle portion 11 is twisted into a helical shape, the rotating direction of the rod body 1 is so arranged that the first bristle portion 11 compels the stirred dust into the storage portion 13. Since there is a discontinuous section of bristle arrangement between the first and second bristle portions 11 and 12, the stirred dust entering the storage portion 13 can only remain in the storage position 13. Thus, the cleaning brush can move deeper into the hole, and the second bristle portion 12 takes over the cleaning job. Accordingly, the dust in the hole can be completely removed to provide a tidy work.

After the cleaning job is finished, the cleaning brush can be moved upward to move the first and second bristle portions 11 and 12 of the rod body 1 out of the hole. Thus, the dust remained on the storage portion 13 free of bristles can be easily removed from the rod body 1. Accordingly, the cleaning brush can rapidly and easily clean the dust. Furthermore, after the hole has been cleaned, an adhesive can be filled into the hole for securely engaging a to-be-connected object in the hole.

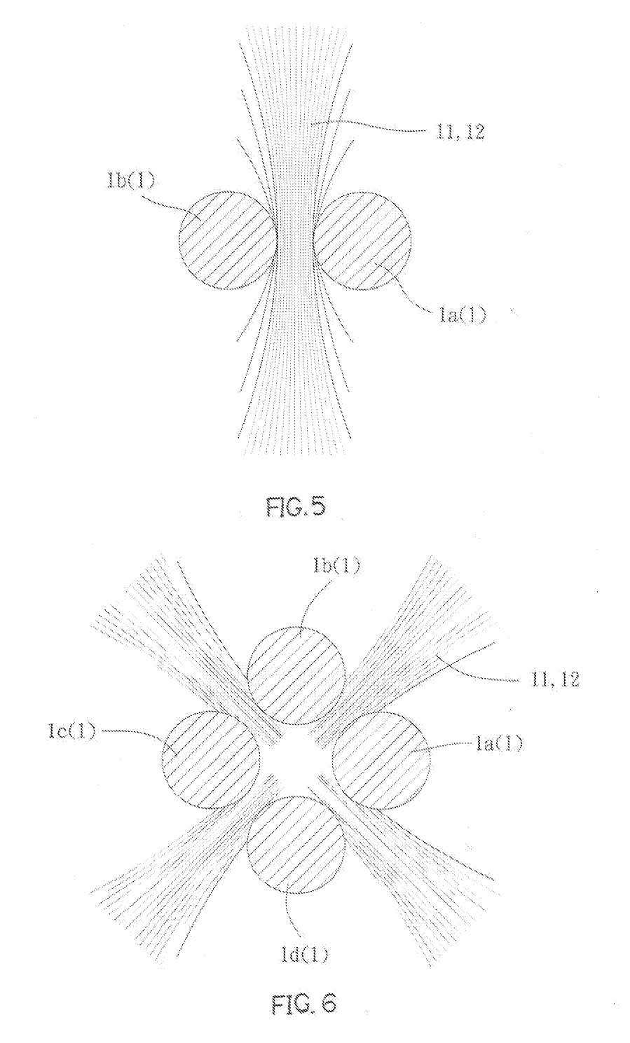

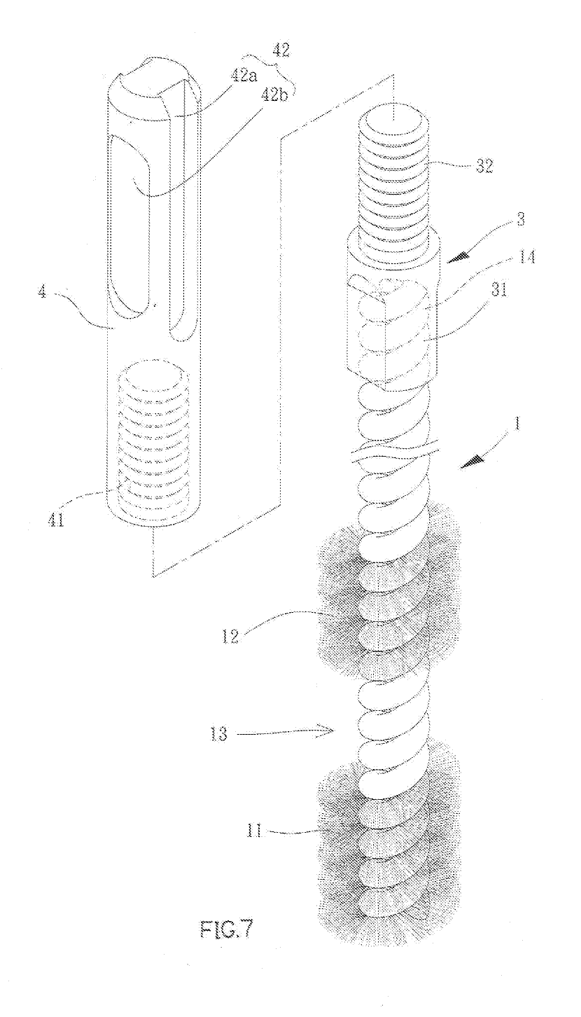

With reference to FIGS. 5 and 6, the rod body 1 can be formed by twisting two metal wires 1a, 1b or four metal wires 1a, 1b, 1c, 1d. At the same time, each metal wire can twist and fix a plurality of bristles between the metal wires. Thus, the first and second bristle portions 11 and 12 can have two or four helical arrangements, which can be appreciated by one having ordinary skill in the art.

FIG. 7 shows a cleaning brush of a second embodiment according to the present invention. In this embodiment, the cleaning brush includes a rod body 1, an engaging member 3, and an extension member 4. The rod body 1 includes first and second bristle portions 11 and 12, a storage portion 13, and a first connecting portion 14, which is identical to the first embodiment.

The engaging member 3 includes a first end and a second end. The first end of the engaging member 3 includes a second connecting portion 31 that can be coupled with the first connecting portion 14 (see FIG. 2) by various provisions. A third connecting portion 32 is formed on the second end of the engaging member 3 and can be in the form of a threaded portion, which can be an inner thread or an outer thread. In this embodiment, the third connecting portion 32 is an outer thread.

The extension member 4 has a first end and a second end. The first end of the extension member 4 includes a fourth connecting portion 41 engaged with the third connecting portion 32. The fourth connecting portion 41 can be a thread portion, which is an inner thread or an outer thread. In this embodiment, the fourth connecting portion 41 is an inner thread. A second engaging portion 42 is formed on the second end of the extension member 4 and can be in the form of an elongated groove 42a, a short slot 42b, or any other conventional coupling structure. Thus, the engaging member 4 can be coupled by the engaging portion 42 with a tool, such as an electric tool, a pneumatic tool, or an electric screw driver, and can be driven by the tool to rotate.

By providing the extension member 4, the rod body 1 of the cleaning brush of the second embodiment according to the present invention can be easily selected and replaced. For example, a suitable rod body 1 can be selected or changed in response to holes of different diameters and lengths or cleaning of dusts of different materials. Alternatively, a suitable extension member 4 can be selected or changed in response to different engaging portions of various tools, which permits application on various tools to achieve wider and more versatile effects.

In view of the foregoing, in the cleaning brush according to the present invention, since the rod body 1 includes the first and second bristle portions 11 and 12 and the storage portion 13 between the first and second bristle portions 11 and 12, when the cleaning brush is used to clean a hole, the first bristle portion 11 firstly stirs up the dust residing in the hole, and the dust can only remain in the storage portion 13. Then, the second bristle 12 proceeds with deeper cleaning to thoroughly remove the dust in the hole. This permits a secure coupling effect of a to-be-connected object by filling an adhesive into the hole after cleaning. After the cleaning job, the dust remaining in the storage portion 13 can be easily removed. Thus, the cleaning brush according to the present invention can rapidly and easily clean the dust, and the user is willing to reuse the cleaning brush. Thus, the cleaning brush has a longer service life.

Although specific embodiments have been illustrated and described, numerous modifications and variations are still possible without departing from the scope of the invention. The scope of the invention is limited by the accompanying claims.

1. A cleaning brush comprising:
a rod body including a first end and a second end, with the first end of the rod body including a first connecting portion, with the second end of the rod body including a first bristle portion and a second bristle portion, and with a storage portion free of bristles formed between the first and second bristle portions; and
an engaging member including a first end and a second end, with the first end of the engaging member including a second connecting portion engaged with the first connecting portion, and with the second end of the engaging member including a first engaging portion.

2. The cleaning brush as claimed in claim 1, wherein the rod body is formed by twisting two metal wires to provide the first and second bristle portions.

3. The cleaning brush as claimed in claim 1, wherein the rod body is formed by twisting four metal wires to provide the first and second bristle portions.

4. The cleaning brush as claimed in claim 1, wherein each of the first and second bristle portions has an axial length, and wherein the axial lengths of the first and second bristle portions are identical or different.

5. The cleaning brush as claimed in claim 1, wherein each of the first and second bristle portions has a rotational diameter when rotated, and wherein the rotational diameters of the first and second bristle portions are identical or different.

6. The cleaning brush as claimed in claim 1, wherein the first and second bristle portions are made of a same material or different materials.

7. The cleaning brush as claimed in claim 1, further including an extension member having a first end and a second end, with a third connecting portion formed on the second end of the engaging member, with the first end of the extension member including a fourth connecting portion engaged with the third connecting portion, and with the second end of the extension member having a second engaging portion.

8. The cleaning brush as claimed in claim 7, wherein the third connecting portion is in threading connection with the fourth connecting portion.
